(19) United States
(12) Patent Application Publication
(10) Pub. No.: US 2021/0365866 A1
(43) Pub. Date: Nov. 25, 2021

(54) SYSTEMS AND METHODS FOR USE OF EMPLOYEE MESSAGE EXCHANGES FOR A SIMULATED PHISHING CAMPAIGN

(71) Applicant: KnowBe4, Inc., Clearwater, FL (US)

(72) Inventors: Greg Kras, Dunedin, FL (US); Coda Babani, Palm Harbor, FL (US); Hector Centeno, Dunedin, FL (US); Christine Kipke, Berlin (DE); Rob Henley, Somerville, MA (US)

(21) Appl. No.: 17/324,742

(22) Filed: May 19, 2021

Related U.S. Application Data
(60) Provisional application No. 63/028,087, filed on May 21, 2020.

(51) Int. Cl. G06Q 10/06; H04L 29/06; H04L 12/58

(52) U.S. Cl. CPC G06Q 10/06395; H04L 51/046; H04L 63/1483; H04L 63/1425

(57) ABSTRACT

Systems and methods are described for facilitating use of employee message exchanges for a simulated phishing campaign. Initially, a message store of one or more users is accessed to retrieve one or more messages from the message store. Further, one or more message characteristics of the one or more messages are identified. The one or more message characteristics are processed to determine contextual information. Based on the contextual information, a simulated phishing communication is generated such that the generated simulated phishing communication is relevant to a user of the one or more users. The simulated phishing communication is then communicated to the user.

### CROSS-REFERENCE TO RELATED APPLICATION

This application claims priority to and the benefit of U.S. Patent Application No. 63/028,087, titled “SYSTEMS AND METHODS FOR USE OF EMPLOYEE MESSAGE EXCHANGES FOR A SIMULATED PHISHING CAMPAIGN,” and filed on May 21, 2020, the contents of all of which are hereby incorporated herein by reference in its entirety for all purposes.

### TECHNICAL FIELD

The present invention generally relates to systems and methods for facilitating the use of employee message exchanges for a simulated phishing campaign. In particular, the systems and the methods relate to using a message store of one or more employees for generating simulated phishing communications for the simulated phishing campaign.

### BACKGROUND

Organizations have recognized phishing as one of the most prominent threats that can cause serious breaches of data including confidential information. Attackers who launch phishing attacks may attempt to evade an organization's security controls and target its employees. To prevent or to reduce the success rate of cyber attacks on employees, an organization may conduct security awareness training for its employees, along with other security measures. Through the security awareness training, the organizations may actively educate their employees on how to spot and report a suspected phishing attack so that they do not fall prey to actual phishing attacks and jeopardize the security of the organization.

As a part of a security awareness training program, an organization may send out simulated phishing communications (for example, simulated phishing emails) periodically or occasionally to devices of the employees and observe responses of the employees to such communications. A simulated phishing communication is intended to resemble a real phishing communication, and real phishing communications are intended to resemble real, authentic communication. A simulated phishing communication may be understood as any communication that is sent to a user with the intent of training the user to recognize attacks that would cause the user to reveal personal or confidential information. In examples, simulated phishing communications may be email, short message service (SMS), instant messaging (IM), or any other electronic method of communication or messaging. The more genuine the simulated phishing communication appears, the more likely an employee will respond to the simulated phishing communication. Since attackers (malicious actors) may specifically target a single employee or a group of employees, creating simulated phishing communications that are highly relevant to individual employees are desired to ensure that the employee is well trained to recognize real phishing attacks.

Currently organizations create simulated phishing communications for their employees based on information gathered about the employees from various sources. For example, an organization may gather information about an employee through an Open Source Intelligence (OSINT) source. Examples of an OSINT source may include media (print, radio, television etc.), internet and social media, public government data, professional and academic publications, commercial data, and grey literature such as technical reports, patents, business documents, unpublished works, and newsletters. In an example, the information gathered about the employee may include employee's name, designation/position of the employee in the organization, contact information of the employee and employee social connections. However, the information gathered about the employee may not be sufficient enough to create a simulated phishing communication that may be highly relevant to the employee. Thus, the employee may fail to interact/respond to the simulated phishing communication, and therefore may not be trained well enough to spot a phishing attempt. As a result, the employee may be vulnerable to phishing attacks and may pose more risk to the organization. Consequently, the organization may be at a security risk possibly leading to a breach of sensitive information of the organization.

### SUMMARY

Systems and methods are described for facilitating use of employee message exchanges for creation of a simulated phishing campaign. In particular, the systems and the methods relate to using a message store of one or more employees for generating simulated phishing communications.

Systems and methods are provided for using a message store for generating a simulated phishing communication. In an example embodiment, a method for using a message store for generating simulated phishing communications is described which includes accessing a user message store and identifying one or more message characteristics of one or more messages in the message store. Then, contextual information is determined from the one or more message characteristics to generate a simulated phishing communication relevant to a user of the one or more users. Next, the simulated phishing communication is generated based at least on the contextual information and communicated to the user.

In some implementations, the method includes accessing the message store of one or more users that exchange messages.

In some implementations, one or more messages are forwarded to the message store from a second message store or a messaging application of the one or more users.

In some implementations, the method includes scanning content of the one or more messages.

In some implementations one or more message characteristics include one or more of the following: keywords, links or phone numbers.

In some implementations, one or more message characteristics include one or more of the following: a date and a time of transmission or receipt, the frequency of messages, message participants and message status.

In some implementations, the one or more message characteristics include one or more of the following: a message structure, a message format, an image or a logo, one or more attachments or one or more software tools used by the users.

In some implementations, the method includes generating the simulated phishing communication based at least on the contextual information identifying one or more topics, dates or times or message types relevant to the user.

In some implementations, the method includes applying an artificial intelligence model to the contextual information and determining the selected contextual information that was more effective for the simulated phishing communication, and generating and communicating a subsequent simulated phishing communication to the user based on the selected information.

In an example embodiment, a system for using a message store for generating a simulated phishing communication is described. The system includes one or more processors, coupled to memory, and configured to access a message store of one or more users, identify one or more message characteristics of the messages in the message store and determine contextual information from the one or more message characteristics to generate a simulated phishing communication relevant to a user, generate the simulated phishing communication based at least on contextual information; and communicate the simulated phishing communication to the user.

In some implementations, the one or more processors are configured to access the message store of the one or more users that exchange messages.

In some implementations, the one or more messages are forwarded to the message store from one of a second message store or a messaging application of the one or more users.

In some implementations, the content of the messages are scanned.

In some implementations, the one or more message characteristics includes one or more of the following: one or more keywords, one or more links and one or more phone numbers.

In some implementations, the one or more message characteristics includes one or more of the following: a date and a time of transmission or receipt, a frequency of the one or more messages, message participants and a message status.

In some implementations, the one or more message characteristics comprise one or more of the following: a message structure, a message format, an image or a logo, one or more attachments and one or more software tools used by the one or more users.

In some implementations, the simulated phishing communications are generated based at least on the contextual information identifying one or more topics relevant to the user, one or more dates or times relevant to the user and/or one or more message types relevant to the user.

In some implementations an artificial intelligence model applied to at least the contextual information is used to determine a selected contextual information that was more effective for the simulated phishing communication and communicate a subsequent simulated phishing communication to the user generated based at least on the selected contextual information.

Other aspects and advantages of the invention will become apparent from the following detailed description, taken in conjunction with the accompanying drawings, which illustrate by way of example the principles of the invention.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client devices in communication with server devices, according to some embodiments;

FIG. 1B is a block diagram depicting a cloud computing environment comprising client devices in communication with cloud service providers, according to some embodiments;

FIGS. 1C and 1D are block diagrams depicting embodiments of computing devices useful in connection with the methods and systems described herein, according to some embodiments;

FIG. 2 depicts an implementation of some of the architecture of a system for using a message store for generating a simulated phishing communication, according to some embodiments; and

FIGS. 3A and 3B depict a flow chart for generating a simulated phishing communication based on a message store of one or more users, according to some embodiments.

### DETAILED DESCRIPTION

For the purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods for facilitating the use of employee message exchanges for a simulated phishing campaign. In particular, the systems and the methods relate to using a message store of one or more employees for generating simulated phishing communications for the simulated phishing campaign.

### A. Computing and Network Environment

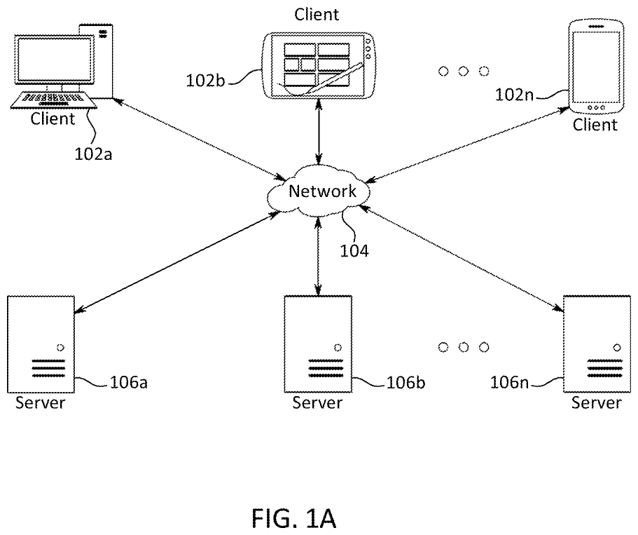

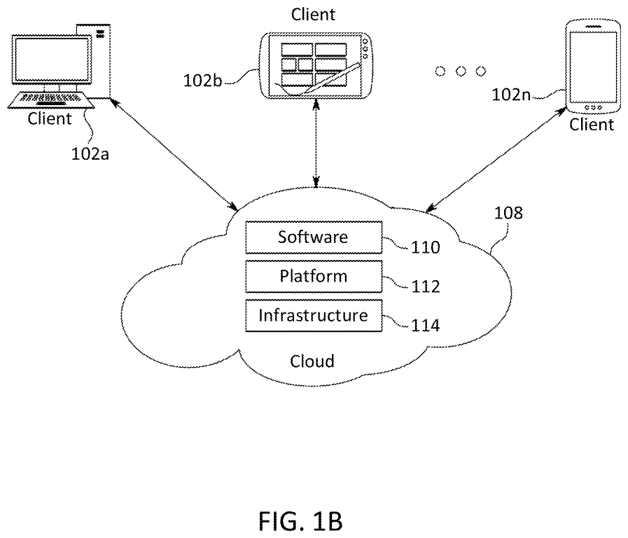

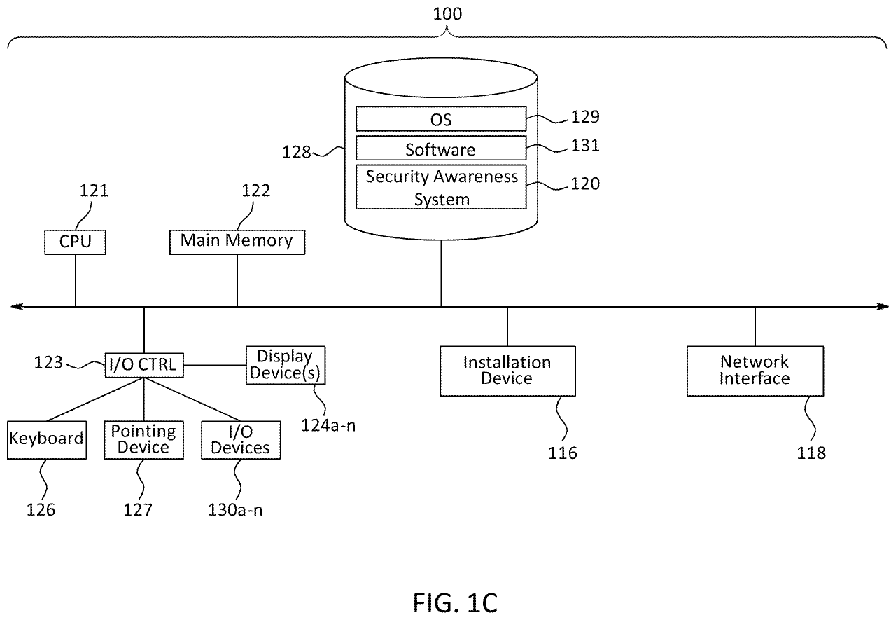

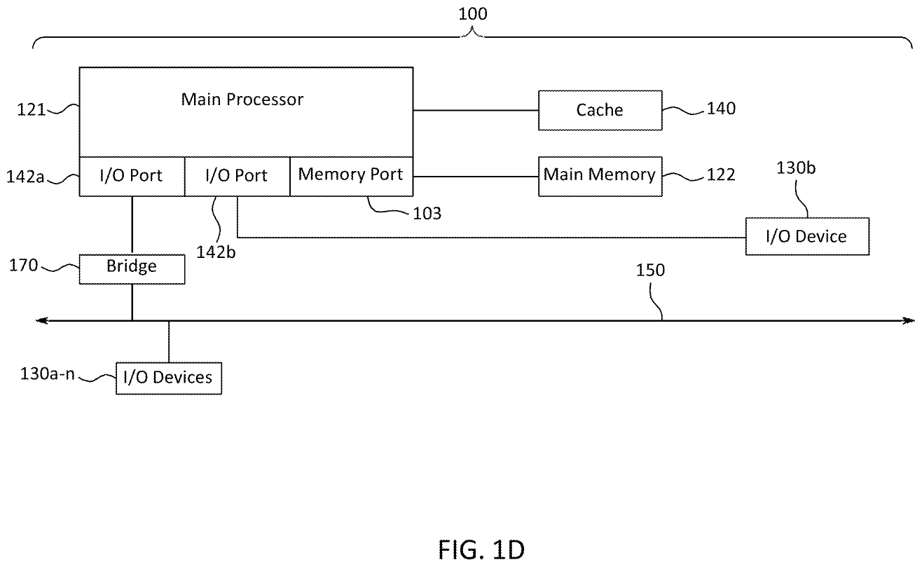

Prior to discussing specific embodiments of the present solution, it may be helpful to describe aspects of the operating environment as well as associated system components (e.g. hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, client 102 has the capacity to function as both a client node seeking access to resources provided by a server and as a server providing access to hosted resources for other clients 102a-102n.

Although FIG. 1A shows a network 104 between clients 102 and the servers 106, clients 102 and servers 106 may be on the same network 104. In some embodiments, there are multiple networks 104 between clients 102 and servers 106. In one of these embodiments, network 104′ (not shown) may be a private network and a network 104 may be a public network. In another of these embodiments, network 104 may be a private network and a network 104′ may be a public network. In still another of these embodiments, networks 104 and 104′ may both be private networks.

Network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g. FDMA, TDMA, CDMA, or SDMA. In some embodiments, different types of data may be transmitted via different links and standards. In other embodiments, the same types of data may be transmitted via different links and standards.

Network 104 may be any type and/or form of network. The geographical scope of the network may vary widely and network 104 can be a body area network (BAN), a personal area network (PAN), a local-area network (LAN), e.g. Intranet, a metropolitan area network (MAN), a wide area network (WAN), or the Internet. The topology of network 104 may be of any form and may include, e.g., any of the following: point-to-point, bus, star, ring, mesh, or tree. Network 104 may be an overlay network which is virtual and sits on top of one or more layers of other networks 104′. Network 104 may be of any such network topology as known to those ordinarily skilled in the art capable of supporting the operations described herein. Network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. Network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, servers 106 may be geographically dispersed. In other embodiments, a machine farm may be administered as a single entity. In still other embodiments, the machine farm includes a plurality of machine farms. Servers 106 within each machine farm can be heterogeneous—one or more of servers 106 or machines 106 can operate according to one type of operating system platform (e.g., Windows, manufactured by Microsoft Corp. of Redmond, Wash.), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In the embodiment, consolidating servers 106 in this way may improve system manageability, data security, the physical security of the system, and system performance by locating servers 106 and high-performance storage systems on localized high-performance networks. Centralizing servers 106 and storage systems and coupling them with advanced system management tools allows more efficient use of server resources.

Servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, Calif.; the Xen hypervisor, an open source product whose development is overseen by Citrix Systems, Inc. of Fort Lauderdale, Fla.; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif. Additional layers of abstraction may include Container Virtualization and Management infrastructure. Container Virtualization isolates execution of a service to the container while relaying instructions to the machine through one operating system layer per host machine. Container infrastructure may include Docker, an open source product whose development is overseen by Docker, Inc. of San Francisco, Calif.

Management of the machine farm may be de-centralized. For example, one or more servers 106 may comprise components, subsystems and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with cloud 108 over one or more networks 104. Clients 102 may include, e.g., thick clients, thin clients, and zero clients. A thick client may provide at least some functionality even when disconnected from cloud 108 or servers 106. A thin client or zero client may depend on the connection to cloud 108 or server 106 to provide functionality. A zero client may depend on cloud 108 or other networks 104 or servers 106 to retrieve operating system data for the client device 102. Cloud 108 may include back end platforms, e.g., servers 106, storage, server farms or data centers.

Cloud 108 may be public, private, or hybrid. Public clouds may include public servers 106 that are maintained by third parties to clients 102 or the owners of the clients. Servers 106 may be located off-site in remote geographical locations as disclosed above or otherwise. Public clouds may be connected to servers 106 over a public network. Private clouds may include private servers 106 that are physically maintained by clients 102 or owners of clients. Private clouds may be connected to servers 106 over a private network 104. Hybrid clouds 109 may include both the private and public networks 104 and servers 106.

Cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers, virtualization or containerization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g. Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java Application Program Interfaces (APIs), JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources using web-based user interfaces, provided by a web browser (e.g. Google Chrome, Microsoft Internet Explorer, or Mozilla Firefox provided by Mozilla Foundation of Mountain View, Calif.). Clients 102 may also access SaaS resources through smartphone or tablet applications, including e.g., Salesforce Sales Cloud, or Google Drive App. Clients 102 may also access SaaS resources through the client operating system, including e.g. Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

Client 102 and server 106 may be deployed as and/or executed on any type and form of computing device, e.g., a computer, network device or appliance capable of communicating on any type and form of network and performing the operations described herein.

FIGS. 1C and 1D depict block diagrams of a computing device 100 useful for practicing an embodiment of client 102 or server 106. As shown in FIGS. 1C and 1D, each computing device 100 includes central processing unit 121, and main memory unit 122. As shown in FIG. 1C, computing device 100 may include storage device 128, installation device 116, network interface 118, and I/O controller 123, display devices 124a-124n, keyboard 126 and pointing device 127, e.g., a mouse. Storage device 128 may include, without limitation, operating system 129, software 131, and a software of security awareness system 120. As shown in FIG. 1D, each computing device 100 may also include additional optional elements, e.g., a memory port 103, bridge 170, one or more input/output devices 130a-130n (generally referred to using reference numeral 130), and cache memory 140 in communication with central processing unit 121.

Central processing unit 121 is any logic circuitry that responds to and processes instructions fetched from main memory unit 122. In many embodiments, central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. Computing device 100 may be based on any of these processors, or any other processor capable of operating as described herein. Central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, main memory 122 or storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. Main memory 122 may be based on any of the above described memory chips, or any other available memory chips capable of operating as described herein. In the embodiment shown in FIG. 1C, the processor 121 communicates with main memory 122 via system bus 150 (described in more detail below). FIG. 1D depicts an embodiment of computing device 100 in which the processor communicates directly with main memory 122 via memory port 103. For example, in FIG. 1D main memory 122 may be DRDRAM.

FIG. 1D depicts an embodiment in which the main processor 121 communicates directly with cache memory 140 via a secondary bus, sometimes referred to as a backside bus. In other embodiments, main processor 121 communicates with cache memory 140 using system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via local system bus 150. Various buses may be used to connect central processing unit 121 to any of I/O devices 130, including a PCI bus, a PCI-X bus, or a PCI-Express bus, or a NuBus. For embodiments in which the I/O device is video display 124, the processor 121 may use an Advanced Graphic Port (AGP) to communicate with display 124 or the I/O controller 123 for display 124. FIG. 1D depicts an embodiment of computer 100 in which main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WIT, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by I/O controller 123 as shown in FIG. 1C. The I/O controller may control one or more I/O devices, such as, e.g., keyboard 126 and pointing device 127, e.g., a mouse or optical pen. Furthermore, an I/O device may also provide storage and/or installation medium 116 for computing device 100. In still other embodiments, computing device 100 may provide USB connections (not shown) to receive handheld USB storage devices. In further embodiments, a I/O device 130 may be a bridge between the system bus 150 and an external communication bus, e.g. a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, computing device 100 may include or connect to multiple display devices 124a-124n, which each may be of the same or different type and/or form. As such, any of I/O devices 130a-130n and/or the I/O controller 123 may include any type and/or form of suitable hardware, software, or combination of hardware and software to support, enable or provide for the connection and use of multiple display devices 124a-124n by computing device 100. For example, computing device 100 may include any type and/or form of video adapter, video card, driver, and/or library to interface, communicate, connect or otherwise use display devices 124a-124n. In one embodiment, a video adapter may include multiple connectors to interface to multiple display devices 124a-124n. In other embodiments, computing device 100 may include multiple video adapters, with each video adapter connected to one or more of display devices 124a-124n. In some embodiments, any portion of the operating system of computing device 100 may be configured for using multiple displays 124a-124n. In other embodiments, one or more of the display devices 124a-124n may be provided by one or more other computing devices 100a or 100b connected to computing device 100, via network 104. In some embodiments, software may be designed and constructed to use another computer's display device as second display device 124a for computing device 100. For example, in one embodiment, an Apple iPad may connect to computing device 100 and use the display of the device 100 as an additional display screen that may be used as an extended desktop. One ordinarily skilled in the art will recognize and appreciate the various ways and embodiments that computing device 100 may be configured to have multiple display devices 124a-124n.

Referring again to FIG. 1C, computing device 100 may comprise storage device 128 (e.g. one or more hard disk drives or redundant arrays of independent disks) for storing an operating system or other related software, and for storing application software programs such as any program related to security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to computing device 100 via bus 150. Some storage device 128 may be external and connect to computing device 100 via a I/O device 130 that provides an external bus. Some storage device 128 may connect to computing device 100 via network interface 118 over network 104, including, e.g., the Remote Disk for MACBOOK AIR by Apple. Some client devices 100 may not require a non-volatile storage device 128 and may be thin clients or zero clients 102. Some storage device 128 may also be used as an installation device 116 and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Computing device 100 (e.g., client device 102) may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on client device 102. An application distribution platform may include a repository of applications on server 106 or cloud 108, which clients 102a-102n may access over a network 104. An application distribution platform may include application developed and provided by various developers. A user of client device 102 may select, purchase and/or download an application via the application distribution platform.

Furthermore, computing device 100 may include a network interface 118 to interface to network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX and direct asynchronous connections). In one embodiment, computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. Network interface 118 may comprise a built-in network adapter, network interface card, PCMCIA network card, EXPRESSCARD network card, card bus network adapter, wireless network adapter, USB network adapter, modem or any other device suitable for interfacing computing device 100 to any type of network capable of communication and performing the operations described herein.

Computing device 100 of the sort depicted in FIGS. 1B and 1C may operate under the control of an operating system, which controls scheduling of tasks and access to system resources. Computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Wash.; MAC OS and iOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

Computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. Computer system 100 has sufficient processor power and memory capacity to perform the operations described herein. In some embodiments, computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, computing device 100 is a gaming system. For example, the computer system 100 may comprise a PLAYSTATION 3, or PERSONAL PLAYSTATION PORTABLE (PSP), PLAYSTATION VITA, PLAYSTATION 4, or a PLAYSTATION 4 PRO device manufactured by the Sony Corporation of Tokyo, Japan, or a NINTENDO DS, NINTENDO 3DS, NINTENDO WII, NINTENDO WII U, or a NINTENDO SWITCH device manufactured by Nintendo Co., Ltd., of Kyoto, Japan, or an XBOX 360 device manufactured by Microsoft Corporation.

In some embodiments, computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.244/MPEG-4 AVC) video file formats.

In some embodiments, computing device 100 is a tablet e.g. the IPAD line of devices by Apple; GALAXY TAB family of devices by Samsung; or KINDLE FIRE, by Amazon.com, Inc. of Seattle, Wash. In other embodiments, computing device 100 is an eBook reader, e.g. the KINDLE family of devices by Amazon.com, or NOOK family of devices by Barnes & Noble, Inc. of New York City, N.Y.

In some embodiments, communications device 102 includes a combination of devices, e.g. a smartphone combined with a digital audio player or portable media player. For example, one of these embodiments is a smartphone, e.g. the iPhone family of smartphones manufactured by Apple, Inc.; a Samsung GALAXY family of smartphones manufactured by Samsung, Inc; or a Motorola DROID family of smartphones. In yet another embodiment, communications device 102 is a laptop or desktop computer equipped with a web browser and a microphone and speaker system, e.g. a telephony headset. In these embodiments, communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, the information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Use of Employee Message Exchanges for a Simulated Phishing Campaign

The following describes systems and methods for facilitating a use of employee message exchanges for a simulated phishing campaign. In particular, the systems and the methods relate to using a message store of one or more employees for generating simulated phishing communications for the simulated phishing campaign.

The systems and the methods of the present disclosure leverage a security awareness system that may determine contextual information pertaining to an employee amongst one or more employees of an organization by analyzing messages and message exchanges in a message store of the one or more employees. An employee may be referred to as a user hereinafter. Contextual information may be understood as a characteristic of a message that is likely to resonate with a user and cause the user to believe the authenticity of a simulated phishing communication generated using the contextual information. For example, a simulated phishing communication may be made more relevant to a user using the contextual information. In an example, the security awareness system may analyze details of the message exchanges in the message store of the one or more users such as content of messages, timing of the messages, participants in the message exchanges, and other details, using Artificial Intelligence (AI), Machine learning (ML) and/or Natural Language Processing (NLP) techniques to automatically determine the contextual information from the messages of the user. The contextual information may interchangeably be referred to as one or more leads or leads. Contextual information or leads may be trends, inferences or other insights derived from message characteristics (obtained from messages of a user) that can be used to make simulated phishing communications highly relevant to the user.

The security awareness system may generate a simulated phishing communication based at least on the contextual information. Since the simulated phishing communication is generated based on the contextual information, the simulated phishing communication may have a higher likelihood of being relevant to the user. The security awareness system may then execute a simulated phishing attack or a simulated phishing campaign targeting the user, to test and develop cybersecurity awareness of the user. In an example, the security awareness system may initiate the simulated phishing campaign by communicating the simulated phishing communication to the user. The simulated phishing communication may train the user to recognize phishing attacks and to gauge the security awareness of the user based on an interaction of the user with the simulated phishing communication (for example, by clicking on a link or opening an attachment in the simulated phishing communication) for further security awareness training. Based on a success or a failure rate of the simulated phishing campaign, the security awareness system may identify contextual information that was effective for the simulated phishing communication. The security awareness system may incorporate the more effective contextual information into a future/subsequent simulated phishing communication such that the future/subsequent simulated phishing communication is of increased relevance to the user.

Accordingly, the systems and the methods of the present disclosure enable determination of contextual information to generate and deliver highly relevant simulated phishing communication to the user. Further, automated determination of the contextual information pertaining to the user based on the message store of the one or more users may significantly minimize the need for human intervention in finding relevant content and using this content to generate simulated phishing communication for the user.

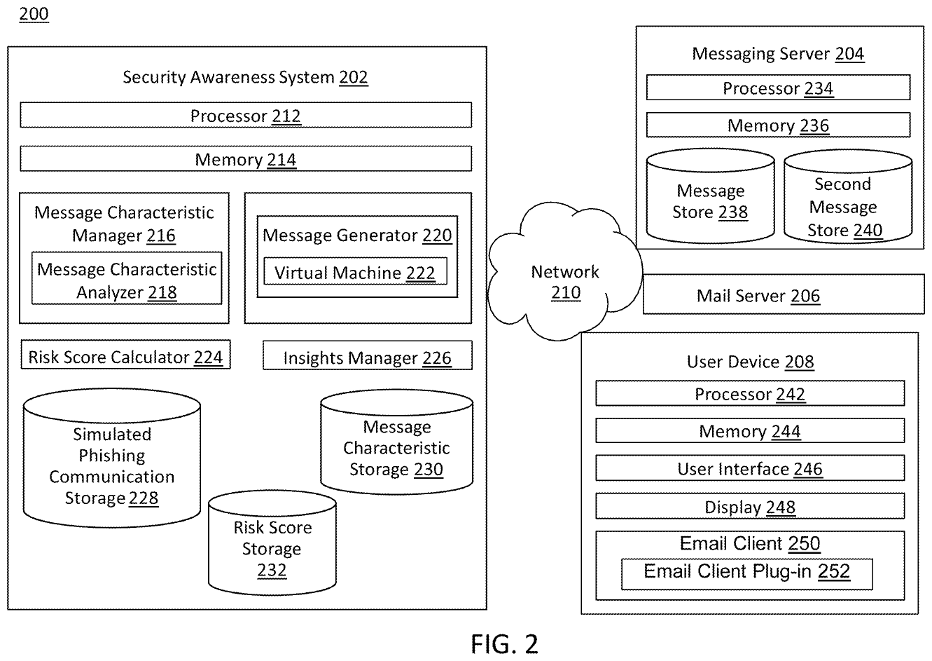

FIG. 2 depicts an implementation of some of the architecture of system 200 for using a message store for generating a simulated phishing communication, according to some embodiments.

System 200 may include security awareness system 202, messaging server 204, mail server 206, user device 208, and network 210 enabling communication between the system components. Network 210 may be an example or instance of network 104, details of which are provided with reference to FIG. 1A and its accompanying description.

According to some embodiments, security awareness system 202 may be implemented in a variety of computing systems, such as a mainframe computer, a server, a network server, a laptop computer, a desktop computer, a notebook, a workstation, and any other computing system. In an implementation, security awareness system 202 may be communicatively coupled with messaging server 204, mail server 206, and user device 208, through network 210 for exchanging information. In an implementation, security awareness system 202 may be implemented in a server, such as server 106 shown in FIG. 1A. In some implementations, security awareness system 202 may be implemented by a device, such as computing device 100 shown in FIGS. 1C and 1D. In an example, security awareness system 202 may be a Computer Based Security Awareness Training (CBSAT) system that performs security services such as performing simulated phishing attacks on a user or a set of users of an organization as a part of security awareness training. For example, security awareness system 202 may perform simulated phishing attacks on the users to assess security awareness of the users and train the users accordingly. In an implementation, security awareness system 202 may be owned or managed or otherwise associated with the organization or a third-party entity. In an implementation, security awareness system 202 may operate in close coordination with messaging server 204 such that security awareness system 202 may screen/analyze incoming messages (to messaging server 204) and/or messages (for example, message exchanges) stored in messaging server 204. In an example, security awareness system 202 may communicate with messaging server 204 through an Application Programming Interface (API) to gain access to the messages.

In some embodiments, security awareness system 202 may include processor 212 and memory 214. For example, processor 212 and memory 214 of security awareness system 202 may be CPU 121 and main memory 122 respectively as shown in FIGS. 1C and 1D. Security awareness system 202 may include a message characteristic manager 216. Message characteristic manager 216 may be an application or a program configured to analyze messages of users and message exchanges between the users of the organization to identify one or more message characteristics. In an example implementation, message characteristic manager 216 may use NLP, AI and/or ML techniques to identify one or more message characteristics from the messages. In some embodiments, message characteristic manager 216 may include message characteristic analyzer 218. In an implementation, message characteristic analyzer 218 may be configured to analyze the one or more message characteristics to determine contextual information for generation of simulated phishing communications.

In some embodiments, security awareness system 202 may include message generator 220 including a virtual machine 222. Message generator 220 may be an application, service, daemon, routine, or other executable logic for generating messages. The messages generated by message generator 220 may be of any appropriate format. For example, they may be email messages, text messages, messages used by messaging applications such as, e.g., WhatsApp™, or any other type of message. The messages may be generated in any appropriate manner, e.g. by running an instance of an application that generates a desired message type, such as running e.g. a Gmail® application, Microsoft Outlook™, WhatsApp™, a text messaging application, or any other appropriate application. The messages may be generated by running a messaging application on virtual machine 222 or on any platform in any other appropriate environment. The messages may be generated to be in format consistent with specific messaging platforms, for example Outlook 365™, Outlook Web Access (OWA), Webmail™, iOS®, Gmail®, and so on. In an implementation, message generator 220 may be configured to generate simulated phishing communications. A simulated phishing communication may test readiness of a user in handling phishing attacks. The simulated phishing communications may interchangeably be referred to as simulated phishing attacks or simulated phishing messages or simulated phishing attack messages.

According to some embodiments, security awareness system 202 may include risk score calculator 224 to determine risk scores for the users. A risk score of a user may be a representation of vulnerability of the user to a malicious attack. Risk score calculator 224 may determine the risk scores based on responses obtained from the users to simulated phishing communications. Security awareness system 202 may further include insights manager 226. In an implementation, insights manager 226 may be an application or a program that analyzes simulated phishing communications to identify contextual information that was successful (or more/most effective) in engaging one or more users to interact with an element (for example, a link and/or an attachment) of the simulated phishing communication. Using the identified/selected contextual information that was more effective for the previous simulated phishing communications, insights manager 226 may generate a fine-tuned and contextually more relevant future or subsequent simulated phishing communication.

Referring back to FIG. 2, in some embodiments, security awareness system 202 may include simulated phishing communication storage 228, message characteristic storage 230, and risk score storage 232. In an implementation, simulated phishing communication storage 228 may store simulated phishing communication templates, message characteristic storage 230 may store the one or more message characteristics of the message exchanges between the users of the organization, and/or one or more message characteristics of message exchanges between users of the organization and persons outside the organization, and risk score storage 232 may store risk scores of the users of the organization. The simulated phishing communication templates stored in simulated phishing communication storage 228, the one or more message characteristics of the message exchanges stored in message characteristic storage 230, and the risk scores of the users stored in risk score storage 232 may be periodically or dynamically updated as required.

According to some embodiments, messaging server 204 may be any server capable of handling data over network 210. In an example, messaging server 204 may handle messages that are sent for use by other programs/applications through an API. In an implementation, messaging server 204 may be a server, such as server 106 shown in FIG. 1A. Messaging server 204 may be implemented by a device, such as computing device 100 shown in FIGS. 1C and 1D. In some embodiments, messaging server 204 may be implemented as a part of a cluster of servers. In some embodiments, messaging server 204 may be implemented across a plurality of servers, thereby tasks performed by messaging server 204 may be performed by the plurality of servers. These tasks may be allocated among the cluster of servers by an application, a service, a daemon, a routine, or other executable logic for task allocation. In an implementation, messaging server 204 may be communicatively coupled with security awareness system 202, mail server 206, and user device 208 through network 210 for exchanging information. Known examples of messaging server 204 include Microsoft® Office 365/Exchange Online, Microsoft® Exchange Server (on Premises), Google® G Suite, and Amazon® WorkMail. In an implementation, messaging server 204 may be owned or managed or otherwise associated with an organization.

In some embodiments, messaging server 204 may include processor 234 and memory 236. For example, processor 234 and memory 236 of messaging server 204 may be CPU 121 and main memory 122 respectively as shown in FIGS. 1C and 1D. In examples, messaging server 204 may include message store 238 and second message store 240. In an implementation, message store 238 may store messages of a user. In an example, message store 238 may store messages that the user sent or exchanged with other users of the organization and/or with any person outside the organization. In some examples, message store 238 may store messages that may be addressed to and/or from the user. In some implementations, second message store 240 may store messages of another user who exchanges messages with the user. In an example, second message store 240 may store messages that may be addressed to and/or from another user. In an implementation, messaging server 204 may provide an API that may allow authorized access to message store 238 and second message store 240. In examples where messaging server 204 is Microsoft® Exchange Online, messaging server 204 may provide a Graph API. Further, in examples where messaging server 204 is Google® G Suite, messaging server 204 may provide a^{Gmail}® API. Other examples of messaging server 204 and corresponding supported APIs are contemplated herein. In an implementation, security awareness system 202 may be provided authorized access to messaging server 204 to access message store 238 and second message store 240 of messaging server 204.

In an implementation, mail server 206 may be any server capable of handling and delivering messages over network 210. In an implementation, mail server 206 may be a server, such as server 106 shown in FIG. 1A. In some implementations, mail server 206 may be implemented by a device, such as computing device 100 shown in FIGS. 1C and 1D. In some embodiments, mail server 206 may be implemented as a part of a cluster of servers. In some embodiments, mail server 206 may be implemented across a plurality of servers, thereby, tasks performed by mail server 206 may be performed by the plurality of servers. These tasks may be allocated among the cluster of servers by an application, a service, a daemon, a routine, or other executable logic for task allocation. Mail server 206 may exchange information with security awareness system 202, messaging server 204, and user device 208, over network 210 using one or more standard messaging protocols and email protocols, such as Post Office Protocol 3 (POP3), Internet Message Access Protocol (IMAP), Simple Message Transfer Protocol (SMTP), and Multipurpose Internet Mail Extension (MIME) Protocol. Known examples of mail server 302 include Microsoft® Exchange Server, and HCL Domino.

In some embodiments, user device 208 may be any device used by a user. In an embodiment, the user may be an employee of an organization or any entity. In some embodiments, the user may be any person using a social networking service, an online consumer store, an online services website and the like. User device 208 as disclosed, may be any computing device, such as a desktop computer, a laptop, a tablet computer, a mobile device, a Personal Digital Assistant (PDA) or any other computing device. In an implementation, user device 208 may be a device, such as client device 102 shown in FIGS. 1A and 1B. User device 208 may be implemented by a device, such as computing device 100 shown in FIGS. 1C and 1D.

According to some embodiment, user device 208 may include processor 242 and memory 244. In an example, processor 242 and memory 244 of user device 208 may be CPU 121 and main memory 122, respectively, as shown in FIGS. 1C and 1D. User device 208 may also include user interface 246 such as a keyboard, a mouse, a touch screen, a haptic sensor, a voice-based input unit, or any other appropriate user interface. It shall be appreciated that components of user device 208 may correspond to components of computing device 100 in FIGS. 1C and 1D, such as keyboard 126, pointing device 127, I/O devices 130a-n and display devices 124a-n. User device 208 may also include display 248, such as a screen, a monitor connected to the device in any manner, or any other appropriate display. In an implementation, user device 208 may display a received message for the user using display 248 and is able to accept user interaction via user interface 246 responsive to the displayed message.

Referring again to FIG. 2, in some embodiments, user device 208 may include email client 250. In one example implementation, email client 250 may be an application installed on user device 208. In another example implementation, email client 250 may be an application that can be accessed over network 210 through a browser without requiring any installation on user device 208. In an implementation, email client 250 may be any application capable of composing, sending, receiving, and reading emails (interchangeably referred to as messages). For example, email client 250 may be an instance of an application, such as Microsoft Outlook™ application, Lotus Notes® application, Apple Mail® application, Gmail® application, or any other known or custom email application. In an example, a user of user device 208 may select, purchase and/or download email client 250, through for example, an application distribution platform. The term “application” may refer to one or more applications, services, routines, or other executable logic or instructions.

In an implementation, email client 250 may include email client plug-in 252. In an implementation, email client plug-in 252 may not be implemented in email client 250 but may coordinate and communicate with email client 250. Further, in an implementation, email client 250 may communicate with email client plug-in 252 over network 210. Other implementations of email client plug-in 252 not discussed here are contemplated herein. In some implementations, email client plug-in 252 may be an interface local to email client 250 that enables email client users, i.e., recipients of emails, to report suspicious emails that they believe may be a threat to them or their organization. An email client plug-in may be an application or program that may be added to an email client for providing one or more additional features which enables customization. The email client plug-in may be provided by the same entity that provides the email client software, or may be provided by a different entity. In an example, email client may include plug-ins providing a User Interface (UI) element such as a button to trigger a function. Functionality of email client plug-ins that use a UI button may be triggered when a user clicks the button. Some examples of email client plug-ins that use a button UI include but are not limited to, a Phish Alert Button (PAB) plug-in, a task create plug-in, a spam marking plug-in, an instant message plug-in and a search and highlight plug-in.

In an implementation, email client plug-in 252 may provide the button plug-in through which function or capabilities of email client plug-in 252 is triggered by a user action on the button. Upon activation, email client plug-in 252 may forward a message (for example, a suspicious message) to a security administrator. In some embodiments, email client plug-in 252 may cause email client 250 to forward a message or a copy of the message to a threat detection platform or an Incident Response (IR) team for threat assessment. In some embodiments, email client 250 or email client plug-in 252 may send a notification to security awareness system 202 that a user has reported a message received at user's mailbox as potentially malicious.

In operation, whenever an organization wishes to provide security awareness training to users of the organization to help mitigate risks associated with potentially malicious attacks such as phishing attacks, security awareness system 202 may communicate with messaging server 204 using an API to gain access to messages of one or more users of the organization. In various embodiments, a user may be understood as an employee or a contractor or anyone who works for the organization. In some embodiments, the user may be a person who is an account holder in a social networking service, an online consumer store, an online services website and any other affiliated person.

Initially, security awareness system 202 may be configured to access a message store of one or more users that exchange messages. In an implementation, security awareness system 202 may access message store 238 of a user. Message store 238 of the user may include one or more messages, message threads, and/or message exchanges pertaining to the user. A message may be referred to as an email message. In an implementation, the one or more messages may be forwarded to message store 238 from one of second message store 240 or a messaging application of the one or more users. In some implementations, the one or more messages of the user may be forwarded to second message store 240 that may be accessible by security awareness system 202. In an example, the one or more messages of the user may be forwarded to second message store 240 without the user's knowledge. In an example, the one or more messages of the user may be forwarded to second message store 240 based on transport rules for a categorizer (or a SMTP categorizer which is a part of the exchange server's transportation engine) defined at mail server 206. In an implementation, any technique may be used that involves forwarding of the one or more messages to second message store 240 may address privacy and regulatory compliance issues and are in line with the organization's policies.

In an implementation, message characteristic manager 216 of security awareness system 202 may be configured to scan and/or analyze content of the one or more messages in message store 238. In an example, message characteristic manager 216 may scan and/or analyze content of the one or more messages in message store 238 using a Virus Scanning API (VSAPI). In an example, message characteristic manager 216 may scan and/or analyze content of all the messages stored in message store 238. In some examples, message characteristic manager 216 may scan and/or analyze content of a subset of the messages stored in message store 238. For example, message characteristic manager 216 may scan and/or analyze content of those messages that may be flagged by the user for some reason. As a result of scanning and/or analysis, message characteristic manager 216 may identify one or more message characteristics of the one or more messages of the user in message store 238. In an example, the one or more message characteristics may include one or more of the following: one or more keywords, one or more links, one or more phone numbers, a date and a time of transmission or receipt, a frequency of the one or more messages being sent or received, message participants, a message status, a message structure, a message format, an image or a logo, one or more attachments, and one or more software tools used by the one or more users.

In an example, the one or more message characteristics may include one or more keywords. In an implementation, message characteristic manager 216 may scan content of the one or more messages of the user to identify whether one or more specific keywords are present in the one or more messages. For example, message characteristic manager 216 may search for specific words, topics, letters, numbers, and/or phrases in message title, message body, and/or message headers of the one or more messages. In some examples, the one or more message characteristics may include one or more links. In an implementation, message characteristic manager 216 may search for certain types of links, such as unsubscribe links or other types of links which are likely to be found in messages (for example, newsletter emails) that the user may have actively chosen (opted-in) to receive. In some examples, the one or more message characteristics may include one or more phone numbers. In an implementation, message characteristic manager 216 may identify a phone number of the user and/or phone numbers of other users (for example, colleagues of the user) based on scanning of the content of the one or more messages of the user. In an example, message characteristic manager 216 may identify the phone number of the user from an email signature of the user.

In some examples, the one or more message characteristics may include a date and a time of transmission or receipt. In an implementation, message characteristic manager 216 may scan content of each of the one or more messages to identify a date and a time of transmission or receipt of each message. For example, message characteristic manager 216 may identify a specific date and/or a time at which each message was sent or received, opened, read, archived, etc. In some examples, the one or more message characteristics may include a frequency of the one or more messages. In an implementation, message characteristic manager 216 may identify a total frequency of messages received by the user over a period of time. In an example, message characteristic manager 216 may identify the total frequency of messages based on date, day, and/or time criteria. For example, in an average week, the user may receive a message every 10 minutes or the user may receive a message every minute each morning between 8 AM to 10 AM. Message characteristic manager 216 may narrow or broaden the observation of frequency of messages by time of day, or any time, or date-based data. There are examples provided herein that consider frequency of messages as the one or more message characteristics may be used to determine when the user generally receives a most or a least number of messages.

In some examples, the one or more message characteristics may include message participants or message thread participants. In an implementation, message characteristic manager 216 may be configured to identify the message participants or the message thread participants, and in some implementations, a frequency of communication between the message thread participants. In an example, to identify the frequency of communication between the message thread participants, message characteristic manager 216 may search for distribution of internal messages (within the user's organization) against external messages that the user receives and/or sends. For example, message characteristic manager 216 may search for groups of users to whom messages are frequently sent. In an example, message characteristic manager 216 may identify a manager of the user, project colleagues, and other users as participants of a message or a message thread.

Further, in some examples, the one or more message characteristics may include a message status. In an example, the message status may be assigned to a message by email client 250. Examples of a message status assigned by email client 250 may include “opened”, “unread”, and other statuses. In some examples, the message status may be assigned by a sender of the message (for example, marked as urgent, flagged for follow up etc.). In some examples, the user may confer a status onto a message (for example, opened, unread, marked as urgent, flagged for follow up, and marked as junk or spam). In an implementation, message characteristic manager 216 may analyze the one or more messages of the user to identify a message status of the one or more messages. In some examples, the one or more message characteristics may include a message structure. In an implementation, message characteristic manager 216 may identify a message structure or a message layout of the one or more messages. For example, message characteristic manager 216 may identify color schemes and relative positions of items, such as title, header, text, images, Graphics Interchange Formats (GIFs), and signature(s) in the one or more messages.

In some examples, the one or more message characteristics may include a message format. In an implementation, message characteristic manager 216 may analyze the content of each of the one or more messages to identify whether each message is in a plaintext format, a Hypertext Markup Language (HTML) format, or a rich text format. Also, in some examples, the one or more message characteristics may include an image or a logo included in the one or more messages. In an implementation, message characteristic manager 216 may search for images and logos in the one or more messages. In some examples, the one or more message characteristics may include one or more attachments. For example, a message characteristic may be a number of attachments included in a message, the format of the attachments included in the message (for example, “.doc”, “.xls”, “.pdf”, “.txt”, “.exe”, or any other format), a frequency of receiving the attachments by the user, and/or content of the attachments. In some examples, the one or more message characteristics may include one or more software tools used by the user. In an implementation, message characteristic manager 216 may analyze the one or more messages of the user to identify software tools commonly used by the user. In an example, message characteristic manager 216 may identify the software tools commonly used by the user based on content of the one or more messages and recent messages related to the software tools (for example, a help ticket).

Although it has been described that message characteristic manager 216 accesses message store 238 and/or second message store 240 and identifies the one or more message characteristics of the one or more messages of the user, in some implementations, message characteristic manager 216 may access message stores of other users of the organization to identify message characteristics of messages of the user and other users. In some embodiments, message characteristic manager 216 may store the one or more message characteristics of the messages of the one or more users in message characteristic storage 230 for use in generating contextual information. Also, in some implementations, message characteristic manager 216 may access mail server 206 and email client 250 of the user and other users of the organization to identify message characteristics of messages. In some embodiments, the steps performed by message characteristic manager 216 and described herein in identifying one or more message characteristics of the one or more messages of the user may be performed by messaging server 204.

According to some embodiments, message characteristic analyzer 218 may retrieve the one or more message characteristics of the one or more messages of the user from message characteristic storage 230. Further, message characteristic analyzer 218 may analyze the one or more message characteristics to determine contextual information from the one or more message characteristics. The contextual information may interchangeably be referred to as one or more leads. In an implementation, message characteristic analyzer 218 may use an NLP model, an AI model and/or a ML model to automatically determine the contextual information. Contextual information may be understood as a characteristic of a message that is likely to resonate with a user and cause the user to believe the authenticity of a simulated phishing communication generated using the contextual information. For example, a simulated phishing communication may be made more relevant to a user using the contextual information. The contextual information may be used for generating simulated phishing communications that are highly relevant to the user. The one or more messages and the one or more message characteristics may hereinafter be referred to as the messages and the message characteristics, respectively, for the sake of brevity.

In an implementation, message characteristic analyzer 218 may determine contextual information from one or more keywords in the messages that could be topics relevant to the user. In an example, message characteristic analyzer 218 may analyze the one or more keywords identified by message characteristic manager 216 to determine one or more topics relevant to the user. In an example, message characteristic analyzer 218 may analyze the one or more keywords using the NLP model/algorithm such as Term Frequency-Inverse Document Frequency (TFIDF) algorithm. In some examples, message characteristic analyzer 218 may use a topic extraction console of known or proprietary text mining tools using clustering-based sentiment analysis of the messages characteristics to determine topics, contexts around the topics, and important words. For example, message characteristic analyzer 218 may use clustering-based sentiment analysis to analyze essential words and topics, and tone of the words to determine the contextual information.

In another example, a re-use of a topic of a recent message within a follow up message may be determined as contextual information by message characteristic analyzer 218. For example, a user may have received an email to notify the user that a fire alarm test will take place at 10 AM at his or her office premises. The likelihood that the user may trust a follow up email on the same topic (fire alarm test) may serve as contextual information. As an example, the follow up email may ask the user to click on a link if the fire alarm (identified contextual information) was clearly audible to the user.

In some implementations, message characteristic analyzer 218 may determine contextual information from one or more links identified in the messages that the user is likely to trust. For example, message characteristic analyzer 218 may search for unsubscribe links. An unsubscribe link may imply user's consent to receiving the message (because the message may have been received in response to a subscription). In an example, presence of an unsubscribe link in an email (or a message) may indicate that the email is received from an entity (sender) with whom the user has an existing relationship and the user has subscribed to receive emails from the entity. The presence of the unsubscribe link may also indicate a sense of trust of the user on the entity. The likelihood that the user may trust an email (or a message) that appear to be delivered from the same source (trusted entity) and in a familiar format may serve as contextual information.

According to some implementation, message characteristic analyzer 218 may determine contextual information from the message characteristic such as phone numbers. Message characteristic analyzer 218 may analyze the messages to identify phone numbers (for example, the phone number of the user and/or the phone numbers of the other users) from the messages/message threads to determine contextual information. In an example, phone numbers identified from message threads can be used as contextual information to add credibility to simulated phishing communications. For example, a simulated phishing communication may include the text “Please click on this link to register for the Saturday Sports event and if you have any questions, please call me on this phone number,” where the phone number provided is a number that has been extracted from a message and is familiar to the user. In an example, the phone numbers may be used in simulated phishing communications (for example, simulated vishing attacks and/or simulated smishing attacks). In an example, a simulated vishing attack could be made to appear from a phone number that the user would recognize, thus prompting the user to trust a call from that phone number.

In an implementation, message characteristic analyzer 218 may determine contextual information from dates and times of transmission or receipt of messages by the user. For example, message characteristic analyzer 218 may analyze a date and/or a time that a message is sent, received, opened, etc. to derive insight that may be used for determination of contextual information. In an example, based on the time that the messages of the user are opened, message characteristic analyzer 218 may determine when the user typically opens the messages. For example, based on the time that the messages of the user are opened, message characteristic analyzer 218 may determine a best possible time to send a simulated phishing communication to the user. In some examples, a count of messages that the user receives during a given date range may provide an insight as to when the user receives the greatest number of messages. The insight based on dates and times may serve as contextual information which may be used, for example, to determine a best possible date and/or time to send a simulated phishing communication to the user.

In some implementations, message characteristic analyzer 218 may determine contextual information from a frequency at which the user may exchange (send and/or receive) messages with other users. In an example, message characteristic analyzer 218 may create a histogram of time slices to analyze how often (for example, in a day) the user receives and/or sends messages in a time slice. In some examples, message characteristic analyzer 218 may analyze messages to identify seasonal messages such as messages for holidays, company quarters, seasons, a range of times and/or dates in message threads, etc. or anything else involving a count of messages in a given time frame. The analysis may include looking at the frequency at which a user sends or receives messages with other users which may provide contextual information based on frequency at which the user may exchange messages.

In an implementation, message characteristic analyzer 218 may determine contextual information from information associated with participants in the messages and/or message threads. In an example, message characteristic analyzer 218 may generate a relationship map based on the participants in the messages or in the message threads that involves the user. In some examples, message characteristic analyzer 218 may identify contextual information from the relationship map. The relationship map may indicate/reveal the relationship of the user with other users, such as peers, project colleagues, line managers, workplace superiors, etc. In an example, the relationship map may indicate a count of messages (or a percentage of messages) that are sent to the user personally and a count of messages (or a percentage of messages) that are sent/received to a group of users including the user. In some examples, the relationship map may include/indicate analysis of whether the user has sent/received the messages directly (i.e., whether the user is addressed in “to:” field of the messages), or whether the user is copied (i.e., whether the user is addressed in “cc:” field of the messages) in the messages. In an implementation, the message characteristic analyzer 218 may determine contextual information from the messages that may be linked as a part of a past or an ongoing message thread.

According to an implementation, message characteristic analyzer 218 may determine contextual information from message status of the one or more messages of the user. In an example, message characteristic analyzer 218 may identify the typical disposition or status of different messages or message threads (for example, opened, unread, marked as urgent, flagged, marked as junk, reported). Identification of message characteristics associated with messages that the user typically opens is one example of contextual information that can be determined from the message status. In an example, message characteristic analyzer 218 may analyze a tendency for a user to interact with a specific message type. The likelihood that the user may interact with similar message types may serve as contextual information.

In some implementations, message characteristic analyzer 218 may determine contextual information from layout or structure of the messages of the user in message store 238. In an example, message characteristic analyzer 218 may analyze relative positions of the messages and presence of items, such as a title, a header, a text, an image, and a signature in each message. In an implementation, contextual information from the structure of the messages may allow simulated phishing communications to be constructed in such a way that the simulated phishing communications may appear to be visually similar to messages that the user is familiar with. In an implementation, message characteristic analyzer 218 may determine contextual information from a message format of messages that the user most often receives or interacts with. Similar to the structure of the messages, analysis of the structure of the message format of the messages may allow simulated phishing communications to be constructed in such a way that the simulated phishing communications may appear to be visually similar to messages that the user is familiar with.

In some implementations, message characteristic analyzer 218 may determine contextual information from message characteristics such as the images and/or the logos included in the messages. Message characteristic analyzer 218 may analyze the images and/or the logos included in the messages and/or the frequency with which they appear to infer how familiar the user may be with the images and/or the logos. Message characteristic analyzer 218 may determine contextual information by determining familiarity of the user with an image or a logo. The images and/or the logos included in the messages may allow simulated phishing communications to be constructed in such a way that the simulated phishing communications may appear to be visually similar to messages that the user is familiar with. In some implementations, message characteristic analyzer 218 may identify contextual information from message characteristics such as one or more software tools that the user may commonly be using. Message characteristic analyzer 218 may identify and analyze one or more software tools that the user is commonly using, content related to the one or more software tools, and recent messages related to the one or more software tools (e.g. a help ticket) to identify contextual information that can be used for generating simulated phishing communications. In an example, simulated phishing communications may be generated to be related to these commonly used one or more software tools.

Although it has been described that message characteristic analyzer 218 determines the contextual information using a single message characteristic, in some embodiments, message characteristic analyzer 218 may identify the contextual information using a combination of two or more message characteristics. For example, a user may have received a teaser in an email about a sports event in the organization. The teaser may indicate a follow up email in next one hour. The likelihood that the user may trust a follow up email on the same topic (sports), and time of transmission/receipt may serve as contextual information. Using the contextual information, a simulated phishing email in next hour may be transmitted asking the user to click on a link to enroll for a chess league as a part of the sports event.

In some embodiments, the contextual information may be used to create context in order to generate an appropriate/relevant simulated phishing communication targeting one or more users. In an implementation, message characteristic analyzer 218 may determine contextual information from the message characteristics identified from the messages of the user to generate a simulated phishing communication relevant to the user of the one or more users of the organization. In some embodiments, the steps performed by message characteristic analyzer 218 and described herein in determining the contextual information from the message characteristics may be performed by messaging server 204.

Once the contextual information is determined, message generator 220 of security awareness system 202 may generate the simulated phishing communication. In an implementation, message generator 220 may generate the simulated phishing communication based at least on the contextual information. In an example, the simulated phishing communication may be generated based at least on the contextual information identifying one or more topics relevant to the user, one or more dates or times relevant to the user, and/or one or more message types relevant to the user.

Some examples of how contextual information may be determined from message store data to generate the simulated phishing communication are described in current and subsequent paragraphs. In some embodiments, message generator 220 may use contextual information related to keywords for generating the simulated phishing communication for the user. In an example, message generator 220 may utilize the topics that may be extracted from the keywords of the messages of the user to create a subject line or a topic of a text body of the simulated phishing communication. For example, if a company name such as FedEx′ (a global shipping logistics company) is found as a keyword, message generator 220 may use other global shipping logistics companies such as UPS™, USPS™, DHL™, etc. to generate the simulated phishing communication. In an example, message generator 220 may interpret the keywords (or the topics) as a representative of a class of objects. The simulated phishing communication may be generated using any topic/term from the class of representative objects. In an example, simulated phishing communication may not require having exact keywords found in the messages of the users.

In an example, contextual information related to unsubscribe links may be used to generate the simulated phishing communication with similar topics and words. For example, a subscription to Forbes® magazine by the user may trigger generation of a Businessweek® newsletter as the simulated phishing communication by message generator 220. In some implementations, message generator 220 may generate the simulated phishing communication based on contextual information related to a time of a day, a specific day, a month or a year. For example, contextual information derived from the messages of the user may be that an organization's fiscal year ends on March 31^{st}. Accordingly, message generator 220 may generate the simulated phishing communication that may include content corresponding to the fiscal year end synchronized with an actual fiscal year end.

In some embodiments, message generator 220 may generate the simulated phishing communication based on contextual information related to the message participants. In an example, message generator 220 may generate the simulated phishing communication that may appear to be delivered from users with whom the user does not communicate frequently. In an example, message generator 220 may generate the simulated phishing communication that may appear to be delivered from users with whom the user communicates frequently. For example, message generator 220 may configure the simulated phishing communication such that the simulated phishing communication may appear to be copied (for example, use of the “cc:” field) to the other users with whom the user communicates frequently. Accordingly, the simulated phishing communication may appear to be more genuine to the user. In some examples, contextual information about the user's direct manager or subordinate may be used to configure the simulated phishing communication such that the simulated phishing communication may appear to be delivered from the user's direct or indirect manager or the subordinate.

In an implementation, message generator 220 may generate the simulated phishing communication based on contextual information related to a phone number. In an example, message generator 220 may generate the simulated phishing communication based on including text “Please click on this link to register for the Saturday Sports event and if you have any question please call me on this phone number”, where the phone number provided is a number that has been extracted from a message of the user and so is familiar to the user. Thus, the user may be prompted to call the phone number.

According to some embodiments, security awareness system 202 may execute a simulated phishing attack or a simulated phishing campaign. The simulated phishing campaign may include one or more simulated phishing communications created for a single user or for a group of users. In an implementation, security awareness system 202 may be configured to generate the one or more simulated phishing communications according to a template which determines a choice and a timing of sending a specific simulated phishing communication as a part of the simulated phishing campaign. The simulated phishing campaign may be carried out for specific purposes including giving enhanced training to more vulnerable groups of users in the organization. In an example, the simulated phishing campaign may be executed for testing the users' awareness of phishing techniques and the users' ability to identify phishing attacks. For example, the simulated phishing campaign may be executed in order to test and develop cybersecurity awareness of the users. In an example, security awareness system 202 may initiate the simulated phishing campaign based on communicating the generated simulated phishing communication to the user. In some examples, security awareness system 202 may communicate the simulated phishing communication to the user through mail server 206. In some examples, security awareness system 202 may inject the simulated phishing communication directly into the user's mailbox. Although specification describes that security awareness system 202 communicates a single simulated phishing communication to the user, in some implementations, security awareness system 202 may communicate more than one simulated phishing communications to the user.

In some embodiments, security awareness system 202 may be configured to provide security awareness training to the user if the user fails the simulated phishing campaign, that is if the user interacts in some way with the simulated phishing communication. In an example, on receiving the simulated phishing communication, if the user interacts with an element (for example, a link and/or an attachment) of the simulated phishing communication in any way, the user may be traversed to (or presented with) a landing page, such as a web page, where the user may be provided with training related to security awareness. In some cases, the training provided to the user may correspond to a mode of failure exhibited by the user. In some cases, the user, on failing the simulated phishing campaign, may be put into a group of users that are to be provided security awareness training at a later or different time. In an implementation, risk score calculator 224 of security awareness system 202 may calculate and modify a risk score for the user based upon the interaction of the user with the simulated phishing campaign. A risk score of a user may be a representation of vulnerability of the user to a malicious attack. In an example, if the user fails the simulated phishing campaign, then the risk score of the user may go up. In an example, the risk score of the user may come down if the user succeeds the simulated phishing campaign (by ignoring or reporting or deleting the message). In an implementation, risk score calculator 224 may update the user's risk score stored in risk score storage 232. In an example, risk score storage 232 may store risk scores of all users of the organization. In an implementation, data (i.e., risk scores) stored in risk score storage 232 may be analyzed by security awareness system 202 to determine which users pose a security risk based on their risk scores and require cybersecurity awareness training. The manner in which the risk score of the user may be calculated is described henceforth.

According to some embodiments, risk score calculator 224 of security awareness system 202 may calculate the risk score of the user. In an example, a risk score may be a measure of potential risk individualized for the user. In an implementation, risk score calculator 224 may calculate the risk score based on machine-learned predictive analytics. In an example, risk score calculator 224 may calculate the risk score based on a training history, a phishing history, responses to simulated phishing communications and simulated phishing campaigns, demographic information, information about the organization, breach data, user assessment surveys, and data obtained from a Security Information and Event Management (STEM) platform. In some embodiments, risk score calculator 224 may create a risk score framework. The risk score framework may outline data that may be considered in calculating the risk score of the user. In an example, the risk score framework may outline a frequency of receiving real phishing attacks by the user, severity associated with the real phishing attacks, and a method of calculating the risk score.

In an embodiment, risk score calculator 224 may calculate the risk score based on various data sources. In some embodiments, risk score calculator 224 may calculate the risk score based on training records of the user. In an example, a training record of a user may include a count of trainings that the user has completed, time spent by the user in training activities, duration of training modules that the user has completed, and other details related to training or learning related to malicious attacks that the user has undertaken. In some examples, risk score calculator 224 may calculate the risk score based on sophistication of the user's responses to real phishing attacks and simulated phishing communications. In an example, the sophistication of a user's response to various real phishing attacks and simulated phishing communications may be given a score or a ranking. For example, a user's response may be given a score from 0 or 1, representing least sophisticated response, to 5, representing most sophisticated response. Further, the score or the ranking of the user's response to various real phishing attacks and simulated phishing communications may be considered for calculating the risk score of the user. Other ways to calculate the risk score of the user are possible and whilst not explicitly discussed, are contemplated herein.

According to some embodiments, insights manager 226 of security awareness system 202 may determine contextual information that was more (or most) effective for the simulated phishing campaign. In an implementation, insights manager 226 may apply an AI model and/or an ML model to at least the contextual information to determine the selected contextual information that was more (or most) effective for the simulated phishing communication. In an example, the more (or most) effective contextual information may be determined based on analysis of a success rate or a failure rate of the simulated phishing campaign. In an example, if the simulated phishing campaign has a high success rate (for example, many users click on links), then insights manager 226 may infer that the simulated phishing communication is at least in part, relevant to the users. In some examples, if the simulated phishing campaign has a high success rate with a specific user then insights manager 226 may infer that the simulated phishing communication is at least in part, relevant to that specific user. In some examples, if the simulated phishing campaign has a high failure rate, then insights manager 226 may infer that the simulated phishing communication is not very relevant to the users. In an example, if the simulated phishing campaign has a high failure rate with a specific user, then insights manager 226 may infer that the simulated phishing communication is not very relevant to that specific user.

In an implementation, insights manager 226 may use the AI model to determine contextual information that was most relevant to a user (or group of users) based on a response rate of the user to both real phishing messages and simulated phishing communications that include this contextual information. In an example, a user may fail a simulated phishing campaign if the user responds or interacts (such as clicks on a link or opens an attachment) with a simulated phishing communication of the simulated phishing campaign. In some examples, a user may pass a simulated phishing campaign if the user does not respond/interact with the simulated phishing communication. For example, a user may pass a simulated phishing campaign if the user deletes the simulated phishing communication from his or her mailbox, or if the user forwards the simulated phishing communication to a security administrator, or if the user reports the simulated phishing communication using an email client plug-in. In an example, on receiving the simulated phishing communication, if the user suspects that the simulated phishing communication is potentially malicious, the user may report the simulated phishing communication using email client plug-in 252. In an implementation, email client plug-in 252 may provide a User Interface (UI) element such as the PAB in email client 250 of user device 208. In an example, when the user receives the simulated phishing communication and the user suspects that the simulated phishing communication is potentially malicious, then the user may click on the UI element using, for example, a mouse pointer to report the simulated phishing communication. In some implementations, when the user selects to report, via the UI element, the simulated phishing communication, email client plug-in 252 may receive an indication that the user has reported the simulated phishing communication received at the user's mailbox. In response to receiving the indication that the user has reported the simulated phishing communication, email client plug-in 252 may cause email client 250 to forward the simulated phishing communication (suspicious communication) to a threat detection platform or an Incident Response (IR) team for threat assessment. In an implementation, insights manager 226 may use the AI model to identify to which apparent senders of messages a user is most likely to respond. In an example, insights manager 226 may identify which apparent senders add more credibility and relevance to a simulated phishing communication. In some implementations, insights manager 226 may use the AI model to determine if there are certain keywords or key phrases that when used in a simulated phishing communication have a higher probability of causing a user to interact with the simulated phishing communication. In some implementations, insights manager 226 may use the AI model to determine if there is a relationship between certain message subjects and an industry to which a user's organization belongs. In an example, there may be a higher probability of a user interacting with a simulated phishing communication including subjects that are determined to have a relationship with the identified industry to which the user's organization belongs.

In some implementations, insights manager 226 may use the AI model to determine typical communication patterns or habits of a user, for example, a time of a day or days of a week that the user is most likely to respond to a simulated phishing communication. This may be for example during periods when the user receives a huge number of messages and is therefore likely to pay less attention to the simulated phishing communication. In some examples, this situation may arise when the user is outside of his or her normal working hours and may likely to pay less attention to the simulated phishing communication. Accordingly, insights manager 226 may be enabled to identify patterns of behavior for the user. In some implementations, insights manager 226 may use the AI model to determine contextual information that was most relevant to a user based on the response rate of the user to both real phishing messages and simulated phishing communications that include this contextual information.

In an implementation, insights manager 226 may use the AI model to identify effective contextual information for individual users and to analyze trends and relationships to increase the effectiveness of a subsequent/future simulated phishing campaign. By identifying contextual information that was effective and contextual information that was not effective (whether for a specific user, for a group of users, for users who share the same characteristics, for users who belong to the same organization, etc.), insights manager 226 may use the AI model to develop optimal simulated phishing campaigns and associated training.

In an example, insights manager 226 may incorporate the most effective contextual information into the subsequent simulated phishing campaign. In an implementation, insights manager 226 may apply the AI model to at least the contextual information to determine selected contextual information that was more effective for the simulated phishing communication communicated to the user. In an implementation, on determining the more (or most) effective contextual information, insights manager 226 may generate a subsequent simulated phishing communication for the user based at least on the selected contextual information. Accordingly, insights manager 226 may utilize the most effective contextual information from earlier (or previous) simulated phishing campaigns to make future/subsequent simulated phishing campaigns more relevant to the user. In an implementation, insights manager 226 may communicate the subsequent simulated phishing communication to the user.

In some implementations, some or all of the functions performed by insights manager 226, including but not limited to the generation of the subsequent simulated phishing communications and communication of the subsequent simulated phishing communications to the users may be performed by message generator 220. For example, outputs (analysis of most effective contextual information) from insights manager 226 may be provided to message generator 220 for tailoring subsequent simulated phishing campaigns so that simulated phishing communications are of increased relevance to each user.

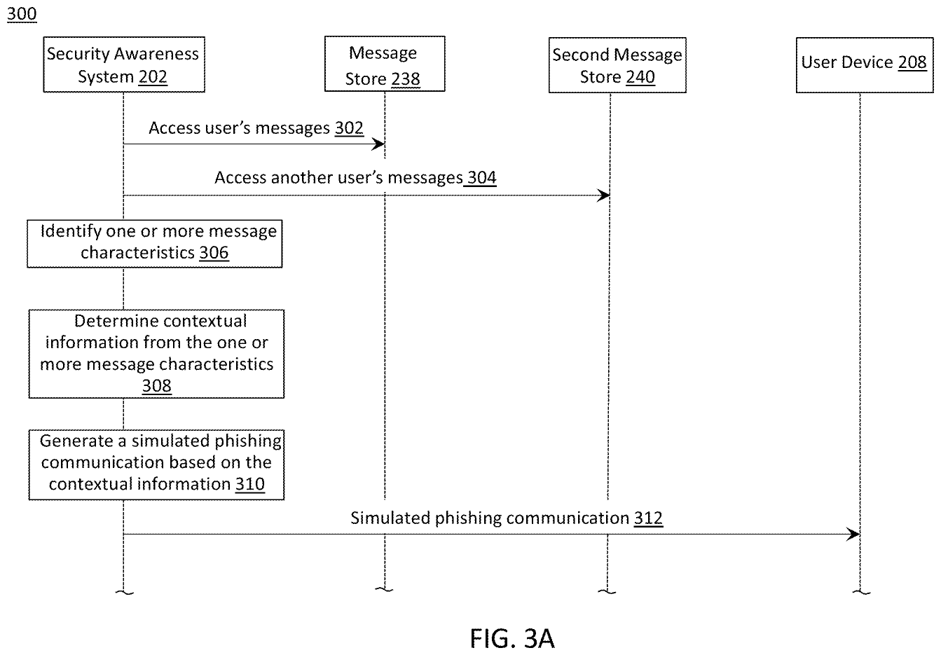

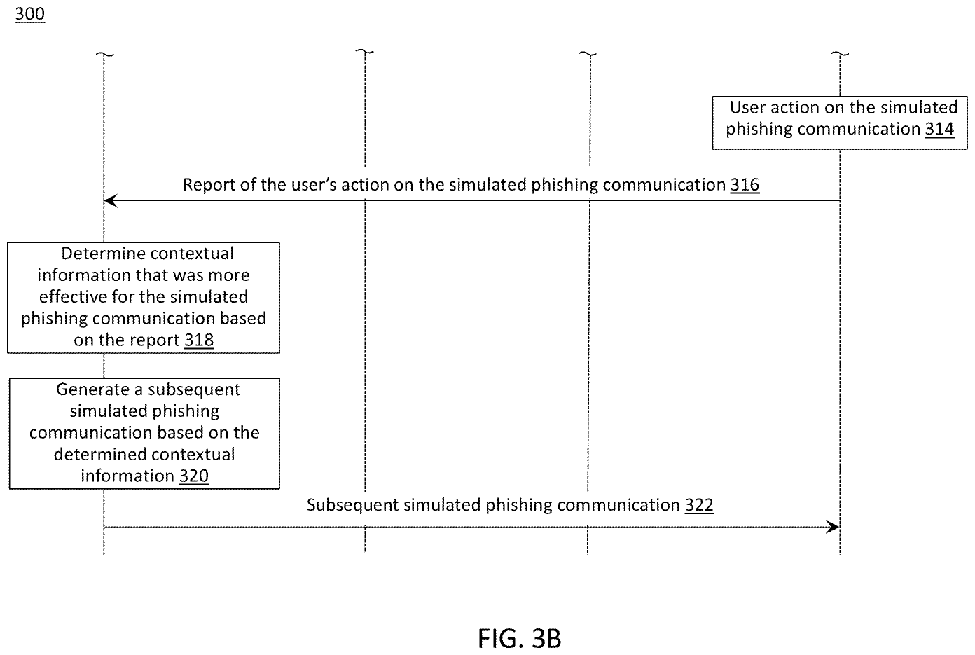

FIGS. 3A and 3B depict a flow chart 300 for generating a simulated phishing communication based on a message store of one or more users, according to some embodiments.

At step 302, in some implementations, security awareness system 202 may access messages and message threads/message exchanges of a user of an organization that may be stored in message store 238. Although the specification describes that security awareness system 202 accesses message store 238 of the user to obtain the messages of the user, in some implementations, one or more messages of the user may be forwarded to message store 238 from one of second message store 240 or a messaging application of one or more users of the organization. In some embodiments, the messages of the user may be forwarded at email client 250 of user device 208 of the user and the security awareness system 202 may access email client 250 to obtain the messages of the user. In an implementation, security awareness system 202 may communicate with messaging server 204 using an API to gain access to message store 238.

At step 304, in some implementations, security awareness system 202 may access messages of another user of the organization that may be stored in second message store 240. In an example, the another user may be any individual who exchanges messages with the user. In an implementation, second message store 240 may store one or more messages of the user that may have been forwarded to second message store 240. In an example, the one or more messages of the user may be forwarded to second message store 240 without the user's knowledge. In an example, the one or more messages of the user may be forwarded to second message store 240 based on transport rules defined at mail server 206. In an implementation, security awareness system 202 may access second message store 240 to access the one or more messages of the user. In an implementation, security awareness system 202 may communicate with messaging server 204 using an API to gain access to second message store 240.

At step 306, in some implementations, security awareness system 202 may identify one or more message characteristics of one or more messages of the user stored in message store 238 and/or second message store 240. In an implementation, security awareness system 202 may scan content of the one or more messages of the user to identify/extract the one or more message characteristics. In an example, the one or more message characteristics may include one or more of the following: one or more keywords, one or more links, one or more phone numbers, a date and a time of transmission or receipt, a frequency of the messages, message participants, a message status, a message structure, a message format, an image or a logo, one or more attachments, and one or more software tools used by the one or more users. In an implementation, security awareness system 202 may scan all the messages stored in message store 238 and/or second message store 240. In some implementations, security awareness system 202 may scan a subset of the messages in message store 238 and/or second message store 240. For example, security awareness system 202 may scan those messages that may have been stored in message store 238 and/or second message store 240 within the last 4 days.

At step 308, in some implementations, security awareness system 202 may determine contextual information from the one or more message characteristics of the one or more messages of the user. In an example, security awareness system 202 may determine the contextual information based on identifying one or more topics relevant to the user, one or more dates or times relevant to the user and/or one or more message types relevant to the user. In an example, security awareness system 202 may analyze a tendency for the user to interact with a specific message type based on the one or more message characteristics of the one or more messages of the user. For example, based on the analysis, security awareness system 202 may determine that the user typically responds/interacts with messages structured like event invitations. The likelihood that the user would respond to messages of similar type may serve as contextual information.

In some examples, security awareness system 202 may identify individuals of significance to the user such as his or her spouse, family members, or superiors within the organization. The likelihood that the user may trust an email that may appear to be delivered from these trusted individuals may serve as contextual information. In some examples, security awareness system 202 may determine travel plans that the user has or other information related to schedule (for example, appointments) of the user to identify the contextual information.

At step 310, in some implementations, security awareness system 202 may generate a simulated phishing communication based at least on the contextual information. Since, the security awareness system 202 generates the simulated phishing communication based on the contextual information determined from the one or more messages of the user, the generated simulated phishing communication may be highly relevant to the user. In an example, security awareness system 202 may generate the simulated phishing communication based at least on the contextual information identifying the one or more topics relevant to the user. In some examples, security awareness system 202 may generate the simulated phishing communication based at least on the contextual information identifying the one or more dates or times relevant to the user. In some examples, security awareness system 202 may generate the simulated phishing communication based at least on the contextual information identifying the one or more message types relevant to the user. In some examples, security awareness system 202 may use a phone number of the user (determined from an email signature of the user) to initiate a combined smishing and phishing attack. For example, security awareness system 202 may generate a simulated phishing communication that may include a text message stating “Your flight has been cancelled. You will receive an email to allow you to rebook”. The user may find the simulated phishing communication highly credible.

In an example, a user who has received an email with an attachment from a reputable source may be inclined to trust a follow up email from the same source. The likelihood that the user would trust a follow up email from the same source may serve as contextual information. Security awareness system 202 may exploit this contextual information in a simulated phishing campaign by, for example, generating a simulated phishing communication (which would serve as a follow up email) that mentions “sorry, wrong attachment on earlier email” to a user. The user may open the attachment without undertaking proper scrutiny of the attachment.

At step 312, in some implementations, security awareness system 202 may communicate the simulated phishing communication to the user of the user device 208. In an example, security awareness system 202 may communicate the simulated phishing communication to the user through mail server 206. In some examples, security awareness system 202 may inject the simulated phishing communication directly into the user's mailbox.

Referring now to FIG. 3B which is a continuation of FIG. 3A, at step 314, in some implementations, on receiving the simulated phishing communication in her or her mailbox, the user of user device 208 may perform an action on the simulated phishing communication. In an example, on receiving the simulated phishing communication, the user may interact with the simulated phishing communication. For example, the user may open an attachment included in the simulated phishing communication or the user may click on a link included in the simulated phishing communication. In some examples, on receiving the simulated phishing communication, if the user suspects that the simulated phishing communication is potentially malicious, then the user may—a) ignore the simulated phishing communication, b) delete the simulated phishing communication from his or her mailbox, c) forward the simulated phishing communication to a security administrator for threat assessment, d) report the simulated phishing communication using email client plug-in 252 of email client 250 of user device 208. In some embodiments, reporting via email client plug-in 252 of email client 250 may cause the simulated phishing communication (suspicious communication) to be forwarded to a threat detection platform for threat assessment. In an implementation, security awareness system 202 may inject a specific header (for example, a X-header) with a predetermined identifier to the simulated phishing communication that the threat detection platform or the security administrator can recognize. In an example, the specific header with the predetermined identifier may indicate that the simulated phishing communication is a simulated communication and not a real phishing communication. Accordingly, on receiving the simulated phishing communication having the specific header, the threat detection platform or the security administrator may discard the simulated phishing communication and may not take any action on the simulated phishing communication.

At step 316, in some implementations, the user's action on the simulated phishing communication may be reported to security awareness system 202. In an example, when the user interacts with the simulated phishing communication, security awareness system 202 may be notified of the same. For example, if the user opens an attachment included in the simulated phishing communication or the user clicks on a link included in the simulated phishing communication, a notification may be sent to security awareness system 202 that the user has interacted with the simulated phishing communication. In some examples, when the user reports the simulated phishing communication, email client plug-in 252 may receive an indication that the user has reported the simulated phishing communication received at the user's mailbox or email account as potentially malicious. In response to receiving the indication that the user has reported the simulated phishing communication as potentially malicious, email client plug-in 252 may cause email client 250 to send a notification to security awareness system 202 that the user has reported the simulated phishing communication received at the user's mailbox as potentially malicious.

At step 318, in some implementations, security awareness system 202 may determine contextual information that was more (or most) effective for the simulated phishing communication based on the report. In an example, security awareness system 202 may use/apply AI model(s) to at least the contextual information to determine a selected contextual information that was more effective for the simulated phishing communication. For example, the AI model(s) may be used to determine the contextual information that was more effective (or relevant) to the user based on a response of the user to the simulated phishing communication that included this contextual information. In an example, contextual information that is related to a user's typical response to certain simulated phishing communication types may be used to increase the likelihood that the simulated phishing campaign does not include simulated phishing communications that the user is unlikely to respond to. For example, if messages structured like newsletters are usually unopened and marked as junk by a user, then it is unlikely that a simulated phishing communication with a newsletter-like template may be responded to by the user.

At step 320, in some implementations, security awareness system 202 may generate a subsequent simulated phishing communication based on the determined contextual information. In an implementation, security awareness system 202 may generate the subsequent simulated phishing communication based at least on the selected contextual information. In an implementation, security awareness system 202 may incorporate the more (or most) effective contextual information into the subsequent simulated phishing communication.

At step 322, in some implementations, security awareness system 202 may communicate the subsequent simulated phishing communication to the user. In some examples, security awareness system 202 may communicate the simulated phishing communication to the user through mail server 206. In some examples, security awareness system 202 may inject the simulated phishing communication directly into the user's mailbox.

Although various embodiments describe generating simulated phishing communication using contextual information and training users (who may be one or more employees, members, and/or contractors) of the organization, the embodiments can be applied for users of online service entities. Some examples of such entities include, but are not limited to, an online consumer store, an online services website, banking services, and any other entity. Phishing attacks are increasing on such online service entities as well due to reservoirs of information such as contact information, user preferences, interests, social circle information, consumer consumption data, subscriptions and financial data including credit/debit/online wallet information. Such information provides a wealth of data for identifying or generating contextual information which can be used in phishing attacks. Various embodiments of the application can be applied to the users of social online service entities. Accordingly the online service entities may educate their users to identify and report messages that appear malicious. The users who reports a suspicious communication early can be suitably rewarded to encourage reporting behaviour. Also immediate reporting of messages that appear malicious may increase the possibility of preventing zero-day attacks.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for using a message store for generating a simulated phishing communication, the method comprising:
accessing, by one or more processors, a message store of one or more users;
identifying, by the one or more processors, one or more message characteristics of one or more messages in the message store;
determining, by the one or more processors, contextual information from the one or more message characteristics to generate a simulated phishing communication relevant to a user of the one or more users;
generating, by the one or more processors, the simulated phishing communication based at least on the contextual information; and
communicating, by the one or more processors, the simulated phishing communication to the user.

2. The method of claim 1, further comprising accessing, by the one or more processors, the message store of the one or more users where the one or more users exchange messages.

3. The method of claim 1, wherein the one or more messages are forwarded to the message store from one of a second message store or a messaging application of the one or more users.

4. The method of claim 1, further comprises scanning, by the one or more processors, content of the one or more messages.

5. The method of claim 1, wherein the one or more message characteristics comprises one or more of the following: one or more keywords, one or more links and one or more phone numbers.

6. The method of claim 1, wherein the one or more message characteristics comprises one or more of the following: a date and a time of transmission or receipt, a frequency of the one or more messages, message participants and a message status.

7. The method of claim 1, wherein the one or more message characteristics comprises one or more of the following: a message structure, a message format, an image or a logo, one or more attachments and one or more software tools used by the one or more users.

8. The method of claim 1, further comprises generating, by the one or more processors, the simulated phishing communication based at least on the contextual information identifying one or more topics relevant to the user.

9. The method of claim 1, further comprises generating, by the one or more processors, the simulated phishing communication based at least on the contextual information identifying one or more dates or times relevant to the user.

10. The method of claim 1, further comprises generating, by the one or more processors, the simulated phishing communication based at least on the contextual information identifying one or more message types relevant to the user.

11. The method of claim 1, further comprising determining, by the one or more processors using an artificial intelligence model applied to at least the contextual information, a selected contextual information that was more effective for the simulated phishing communication and communicating, by the one or more processors, a subsequent simulated phishing communication to the user generated based at least on the selected contextual information.

12. A system for using a message store for generating a simulated phishing communication, the system comprising:
one or more processors, coupled to memory, and configured to:
access a message store of one or more users;
identify one or more message characteristics of one or more messages in the message store;
determine contextual information from the one or more message characteristics to generate a simulated phishing communication relevant to a user of the one or more users;
generate the simulated phishing communication based at least on the contextual information; and
communicate the simulated phishing communication to the user.

13. The system of claim 12, wherein the one or more processors are further configured to access the message store of the one or more users where the one or more users exchange messages.

14. The system of claim 12, wherein the one or more messages are forwarded to the message store from one of a second message store or a messaging application of the one or more users.

15. The system of claim 12, wherein the one or more processors are further configured to scan content of the one or more messages.

16. The system of claim 12, wherein the one or more message characteristics comprises one or more of the following: one or more keywords, one or more links and one or more phone numbers.

17. The system of claim 12, wherein the one or more message characteristics comprises one or more of the following: a date and a time of transmission or receipt, a frequency of the one or more messages, message participants and a message status.

18. The system of claim 12, wherein the one or more message characteristics comprises one or more of the following: a message structure, a message format, an image or a logo, one or more attachments and one or more software tools used by the one or more users.

19. The system of claim 12, wherein the one or more processors are further configured to generate the simulated phishing communication based at least on the contextual information identifying one or more topics relevant to the user.

20. The system of claim 12, wherein the one or more processors are further configured to generate the simulated phishing communication based at least on the contextual information identifying one or more dates or times relevant to the user.

21. The system of claim 12, wherein the one or more processors are further configured to generate the simulated phishing communication based at least on the contextual information identifying one or more message types relevant to the user.

22. The system of claim 12, wherein the one or more processors are further configured to determine, using an artificial intelligence model applied to at least the contextual information, a selected contextual information that was more effective for the simulated phishing communication and communicate a subsequent simulated phishing communication to the user generated based at least on the selected contextual information.
